(19) United States
(12) Patent Application Publication
(10) Pub. No.: US 2017/0357909 A1
(43) Pub. Date: Dec. 14, 2017

(54) SYSTEM AND METHOD TO EFFICIENTLY LABEL DOCUMENTS ALTERNATING MACHINE AND HUMAN LABELLING STEPS

(71) Applicant: Xerox Corporation, Norwalk, CT (US)

(72) Inventors: Jutta Katharina Willamowski, Grenoble (FR); Yves Hoppenot, Notre Dame de Message (FR); Jerome Pouyadou, Grenoble (FR); Michel Langlais, Pont de Claix (FR); Juan-Pablo Suarez, Grenoble (FR)

(73) Assignee: Xerox Corporation, Norwalk, CT (US)

(21) Appl. No.: 15/181,714

(22) Filed: Jun. 14, 2016

(51) Int. Cl. G06N 99/00; G06F 17/30

(52) U.S. Cl. CPC G06N 99/005; G06F 17/30598

(57) ABSTRACT

A system and method that supports the efficient interactive identification of the most paper intensive document categories such that a maximum number of the documents belonging to those categories can be correctly categorized with a minimum effort and within a minimum amount of time is disclosed. Further, an iterative method combining automatic grouping mechanisms with human labelling. The system and method are configured to allow the automatic machine labelling to run iteratively to generate improved document clustering and categorization.

### BACKGROUND

In many contexts, such as the service industry, work is generally organized into processes that often entail printing documents. There is a growing trend towards replacing printing paper documents with digital counterparts, which may entail use of electronic signatures, email (instead of post mail) and online form filling. There are many reasons for this change, including higher productivity, cost-efficiency, and becoming more environmentally-friendly. Many large organizations are therefore looking for solutions to reduce paper usage and to move from using paper to digital documents. Unfortunately, especially in large organizations, it is often difficult to achieve this goal, because of a lack of information. Those in management, for example, often do not have a detailed understanding of where paper is being used by company employees, in particular, in which tasks or subtasks paper documents are generated, as well as how much paper is used in the process, in terms of the volume of paper being used in each of these tasks. Nor is there a good understanding of the reasons why paper is used for these tasks, i.e., what are the barriers that prevent using digital versions instead of paper documents within these tasks.

Having answers to these questions would help organizations to select which processes/tasks could be modified to facilitate moving them from paper to digital. However, without a good understanding of the paper consumption of the various tasks, and the reasons for printing documents, it is difficult to focus these efforts on the processes where changes would be the most effective.

It is now becoming important to not only looking at ways to facilitate printing inside a client corporation, but as well at optimizing printing by replacing inefficient paper workflows by more efficient electronic ones. The reasons for printing documents are often task dependent. Some common reasons involve requiring signatures, archiving, transitions between different computer systems, crossing organizational barriers, and so forth. However, there may be other reasons that have not been identified by the organization. To move from paper to digital, appropriate solutions may need to be implemented to replace the functions previously provided through generating paper documents, such as digital archiving, digital signatures, and the like. However, for some tasks, paper may afford benefits that digital documents do not provide. Paper is, for example, easy portable (e.g., when traveling), easy to read and annotate, and easy to hand over to another person. Employees could be provided with portable devices, such as eReaders, to address some of these issues, but this solution may not be cost-effective.

In this context, consultants are currently able to analyze how and what employees print within a client corporation, to infer associated workflows and to suggest well adapted replacement solutions, reducing paper usage and increasing productivity. Therefore, consultants are currently collecting print volume information directly from the devices and the estimated time spent per employee on the different tasks or processes through a survey. They furthermore conduct individual interviews with selected particularly paper intensive employees to get a deeper understanding of their paper processes. The information can include any kind of electronic document such as print capture, from scan, from content management system or email server, etc.

These similar documents are not necessarily ordered, grouped and displayed side-by-side by default. Whenever the auditor is stuck again in the labelling task, the auditor asks the system for a new iteration, launching another parallel document clustering and training/categorization phase on the reduced set of remaining unlabelled documents. This overall process ends when either all documents are labelled or when a new iteration does not provide any significant improvement in terms of categorization quality or in terms of new significant categories, i.e. when the remaining documents are too scattered and heterogeneous and thus represent either noise or less frequent thus less important categories.

An audit process for paper volume consumption for customers is described. Such audits aim at quantifying the printed paper volume according to its usage in the different customer processes and sub processes. However, the aim of a customer audit is not to build a model that exhaustively covers all document categories appearing in a customer context, but rather to focus on the most relevant ones, essentially covering as much as possible the most paper intensive ones.

In a customer auditing context, recent techniques enable capturing every document on its way to the printer and analyzing it using computer vision and machine learning techniques in order to categorize the document according to its usage. To apply such categorization algorithms, first a representative subset of documents has to be labelled to train categorizer models that can then be applied to the customer's complete document set. This labelling is a manual task that requires human knowledge and that is at the same time time-consuming and demotivating for the user.

Another difficulty in this context is that neither the auditor/user nor the customer can establish the exhaustive list of relevant document categories. This list must therefore be established on the fly, during the labelling process.

There remains a need for a system and method of unusual paper-intensive workflows in a more efficient, open, accurate and motivating fashion, with a need to gather employee knowledge and to combine it with machine learning techniques in a short term and collaborative workshop.

### INCORPORATION BY REFERENCE

The following references, the disclosures of which are incorporated herein by reference in their entireties, are mentioned:

U.S. patent application Ser. No. 14/607,739, filed Jan. 28, 2015, by Willamowski et al., and entitled “SYSTEM AND METHOD FOR THE CREATION AND MANAGEMENT OF USER-ANNOTATIONS ASSOCIATED WITH PAPER-BASED PROCESSES”

U.S. Publication No. 2011/0137898, Published Jun. 9, 2011, by Gordo et al., and entitled “UNSTRUCTURED DOCUMENT CLASSIFICATION”;

U.S. Pat. No. 7,366,705, Issued Apr. 29, 2008, by Zeng et al., and entitled “CLUSTERING BASED TEXT CLASSIFICATION”;

U.S. Pat. No. 8,165,410, Issued Apr. 24, 2012, by Perronnin and entitled “BAGS OF VISUAL CONTEXT-DEPENDENT WORDS FOR GENERIC VISUAL CATEGORIZATION”;

U.S. Pat. No. 8,280,828, issued Oct. 2, 2012, by Perronnin et al., and entitled “FAST AND EFFICIENT NONLINEAR CLASSIFIER GENERATED FROM A TRAINED LINEAR CLASSIFIER”;

U.S. Pat. No. 8,532,399, Issued Sep. 10, 2013, by Perronnin et al., and entitled “LARGE SCALE IMAGE CLASSIFICATION”;

U.S. Pat. No. 8,731,317, issued May 20, 2014, by Sanchez et al., and entitled “IMAGE CLASSIFICATION EMPLOYING IMAGE VECTORS COMPRESSED USING VECTOR QUANTIZATION”;

U.S. Pat. No. 8,879,103, by Willamowski et al., Issued Nov. 4, 2014 and entitled “SYSTEM AND METHOD FOR HIGHLIGHTING BARRIERS TO REDUCING PAPER USAGE”; and

CSURKA et al., “WHAT IS THE RIGHT WAY TO REPRESENT DOCUMENT IMAGES?”, Xerox Research Center Europe, Grenoble, France, Mar. 25, 2016, pages 1-35, are incorporated herein by reference in their entirety.

### BRIEF DESCRIPTION

In one embodiment of this disclosure, described is a computer-implemented method for interactive labelling of documents associated with one or more printing systems used in an organization. The method comprises receiving a representative set of unlabelled printed documents from the one or more printing systems and processing at least one document from the representative set of unlabelled printed documents to generate a plurality of clusters of printed documents, where each cluster contains documents with a subset of similarities. The method further processes at least one document from the representative set of unlabelled printed documents to generate a plurality of categories of printed documents, where each category contains documents with a subset of similarities and then generates a list of clusters and categories for user review. The method receives document clustering information from a system for one or more documents based on the list of clusters and receives document category validation information from a user for one or more documents based on the list of categories. A trainer to classify all or part of a set of labelled documents from the machine learning and human labelling phases is updates and using the updated trainer, classifying one or more printed documents received in step a) which remain unlabelled and displaying to a user a list of categories and clusters generated by the machine learning and human labelling phases and a list of KPIs generated based upon the representative set of unlabelled documents and the labelled documents.

In still another embodiment a system for interactive labelling of documents associated with one or more printing systems used in an organization is described. The system receives a representative set of unlabelled printed documents from the one or more printing systems. A clustering component of the system is configured to process at least one document from the representative set of unlabelled printed documents to generate a plurality of clusters of printed documents, where each cluster contains documents with a subset of similarities. A categorizer component configured to process at least one document from the representative set of unlabelled printed documents to generate a plurality of categories of printed documents, where each category contains documents with a subset of similarities, and a compiler configured to generate a list of clusters and categories for user review. A receiver is configured to receive user document clustering information from a system for one or more documents based on the list of clusters and document category validation information from a user for one or more documents based on the list of categories. A training component is configured to classify all or part of a set of labelled documents from the machine learning and human labelling phases and using the updated trainer, classifying one or more printed documents received in step a) which remain unlabelled and a display configured to display to a user a list of categories and clusters generated by the machine learning and human labelling phases and a list of KPIs generated based upon the representative set of unlabelled documents and the labelled documents.

In still another embodiment, a computer program product comprising a non-transitory recording medium storing instructions which, when executed by a computer processor, performs a method for interactive labelling of documents associated with one or more printing systems used in an organization is described. The method comprises receiving a representative set of unlabelled printed documents from the one or more printing systems, and processing at least one document from the representative set of unlabelled printed documents to generate a plurality of clusters of printed documents, where each cluster contains documents with a subset of similarities. The method further, comprises processing at least one document from the representative set of unlabelled printed documents to generate a plurality of categories of printed documents, where each category contains documents with a subset of similarities. A list of clusters and categories for user review is generated and based upon the list of clusters and categories, the method receives document clustering can category validation information from a user for one or more documents based on the list of clusters. A trainer is updated to classify all or part of a set of labelled documents from the machine learning and human labelling phases, and using the updated trainer, one or more printed documents received in step a) which remain unlabelled are classified. The resulting information is displayed to a user a list of categories and clusters generated by the machine learning and human labelling phases and a list of KPIs generated based upon the representative set of unlabelled documents and the labelled documents.

### BRIEF DESCRIPTION OF THE DRAWINGS

FIG. 1 is a graphical overview of a system and method for analyzing task-related printing alternating machine learning and human labelling steps;

FIG. 2 is illustrates flow chart of system for analyzing task-related printing alternating machine learning and human labelling steps;

FIG. 3 is illustrates categories (labelled) and Clusters (unlabelled) document dashboard with group size representation;

FIG. 4 is illustrates a cluster navigation and presentation;

FIG. 5 illustrates a category navigation and presentation with accept/reject option;

FIG. 6 illustrates selecting a similar function in a cluster or a category;

FIG. 7A illustrates the progress bar showing the number of manually labelled documents, the potential impact thanks to the categorizer and the remaining documents to be done;

FIG. 7B illustrates an efficiency graph showing the number of manually labelled documents vs. time;

FIG. 8 illustrates the volume and homogeneity KPIs for each category/cluster;

FIG. 9A illustrates the cost benefits gauge state right after a machine learning iteration;

FIG. 9B illustrates the cost benefits gauge state dynamically evolving during manual labelling step; and

FIG. 9C illustrates the cost benefits gauge state after several iteration, showing the low cost benefits ratio to continue labelling.

### DETAILED DESCRIPTION

To more effectively gather knowledge about paper-intensive processes in an organization to cluster, categorize and train a system, a system and method that supports the efficient interactive identification of the most paper intensive document categories such that a maximum number of the documents belonging to those categories can be correctly categorized with a minimum effort and within a minimum amount of time is disclosed. Further, an iterative method combining automatic grouping mechanisms with human labelling.

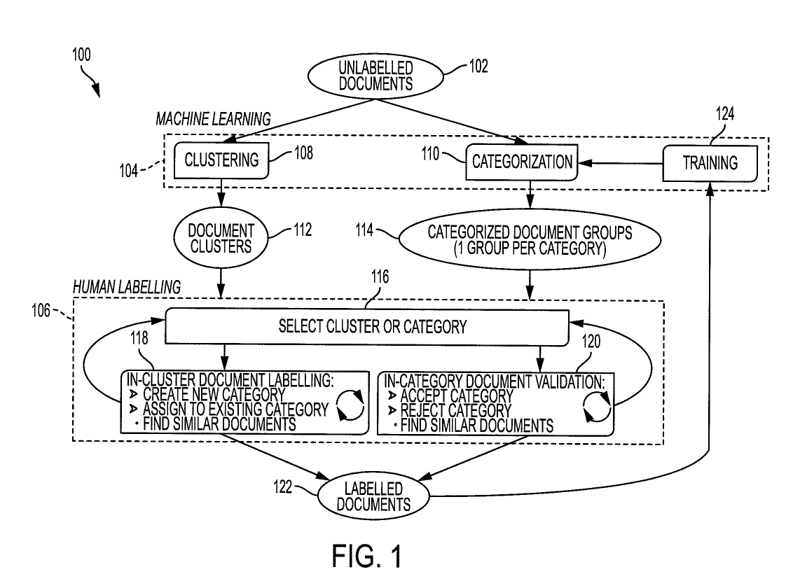

An exemplary method alternates between two phases repeatedly to carry out the labelling process (see FIG. 1). In the machine learning phase, the system, in parallel, clusters and classifies unlabelled documents. In the human labelling phase, the auditor iteratively selects document clusters or categorized document groups for labelling. The auditor controls the transition between these two phases with system support through dedicated indicators. The auditor accesses the proposed system through a simple user experience.

When no labelled documents are readily available, the method begins in an initial clustering step. Clustering groups similar documents together and presents the resulting clusters to the auditor for mass labelling. In the human labelling phase, the auditor then selects individual clusters and assigns them as a whole or in parts to individual categories. The auditor creates and identifies these categories on the fly, during the labelling process, whenever a corresponding document is crossed. When viewing particular documents, the auditor can easily spot and name the category. The list of relevant categories is thus created incrementally following the documents previously viewed and categorized by the auditor.

When the auditor can no longer label the documents, the auditor returns the system to the machine learning phase, which then trains the categorizer using the set of already labelled documents. The resulting categories are then applied to the remaining un-labelled documents. Each document is reviewed by the categorizer and a corresponding category is assigned. In parallel, on the same remaining set of un-labelled documents, the clustering process is performed to identify a set of new meaningful clusters.

In the labelling phase, the auditor can iteratively, i.e., one by one, select either one of the novel clusters for labelling, or one of the categories to verify if the respective proposed documents really belong to that category. In the latter case the auditor can either accept or reject the proposed documents with regard to that category.

When skimming through the documents belonging to a cluster or proposed for a category, the auditor may come across individual particularly prominent documents. The auditor can ask the system to retrieve the subset of similar documents for easier group labelling or category verification in connection with these prominent documents.

When the auditor can no longer label the documents in the labelling phase, the auditor asks the system for a new iteration, launching another parallel document clustering and training/categorization phase on the reduced set of remaining unlabelled documents. This overall process ends when either all documents are labelled or when a new iteration does not provide any significant improvement in terms of categorization quality or in terms of new significant categories, i.e., when the remaining documents are too scattered and heterogeneous and thus represent either noise or less frequent thus less important categories.

The system and method provides an iterative for document labelling, alternating machine learning and a human labelling step. In the machine learning step, the parallel application of the two complementary grouping mechanisms, clustering and categorization, to the remaining set of unlabelled documents, to organize and access them through both clusters and categories for more efficient labelling.

The system and method provide the capability to (a) accept relevant documents proposed by the categorizer to quickly reduce the number of remaining unlabelled documents, and (b) reject irrelevant documents proposed by the categorizer to efficiently refine that categorizer model using the rejected documents as particularly valuable negative examples in the next training phase.

The system and method further provides the ability to select a salient document to (a) identify, retrieve and select the group of similar documents for labelling and (b) reorder the documents according to their similarity with this document.

Lastly, the system and method provides a KPI to gauge current progress, providing feedback about the actual progress and efficiency of the labelling process and its possible impact in terms of coverage of the overall document collection with sufficient confidence. The KPI can further gauge the cost and benefit of labelling more documents according to the current cluster and category characteristics and heterogeneity.

In the context of understanding paper usage, a lot of unlabelled data (i.e., Printed document images) can be easily captured but manual labelling is expensive. The aim of active learning is to optimize the learning process and to identify and select the most valuable examples that the user is then asked to label. In the described system and method, the user controls the process deciding which cluster or a category to begin with. The user, therefore, can progress very quickly towards the goal of identifying and improving the most important categories. The most voluminous categories are the ones the system and method begin with, thus focusing on covering as much as possible of one category. This places the priority on identifying categories with the most number of elements rather than identifying all existing categories where some may have only very few elements (and/or constitute private documents, i.e., noise).

Furthermore, in the proposed system and method, the list of relevant categories is discovered on the fly by the annotator, visually exploring the clusters during the labelling process. With respect to learning and efficiently improving the categorizers, the proposed system and method relies on the human annotator's capability to visually quickly grasp, identify and label homogeneous sets of documents on one hand and spot and identify outliers in the middle of otherwise homogeneous document sets on the other hand. This enables efficient one shot mass labelling of large sets of similar documents from a cluster view on one hand, and efficient spotting of false positive examples among a proposed document set for a category on the other hand.

With reference to FIG. 1, an overview of an exemplary system 100 and method is shown. Overall the proposed system receives unlabelled documents, which can include any kind of electronic document such as print capture, from scan, from content management system or email server, etc. 102 and proceeds through an alternation of machine learning 104 and human labelling steps 106 until all documents are labelled or until no significant new categories can be identified and no significant progress in the categorizer performance is achieved.

In the machine learning clustering phase 108 the remaining unlabelled documents are grouped into clusters 112 of similar documents. The number of clusters is either initially set to a reasonable starting value, or hierarchical clustering may be used to automatically structure the resulting clusters. In the first case, depending on the clustering result, and in particular on their visual homogeneity, the auditor can manually adjust the number of clusters. The aim is to obtain a limited number of homogeneous clusters to enable easy one-shot mass labelling of the corresponding documents. Each of these clusters is then available to the auditor 124 based on the actually available set of already labelled documents 122, but also on the documents explicitly rejected for the different categories. During each iteration, the categorizer models are improved with the additional information provided by the auditor in the prior human labelling phase.

The resulting categorizer models are then applied on the remaining unlabelled documents 102 in order to identify for each category those that belong with high probability to this category. For each category the resulting identified document group 114 is then available to the auditor for validation in the following human labelling phase 106.

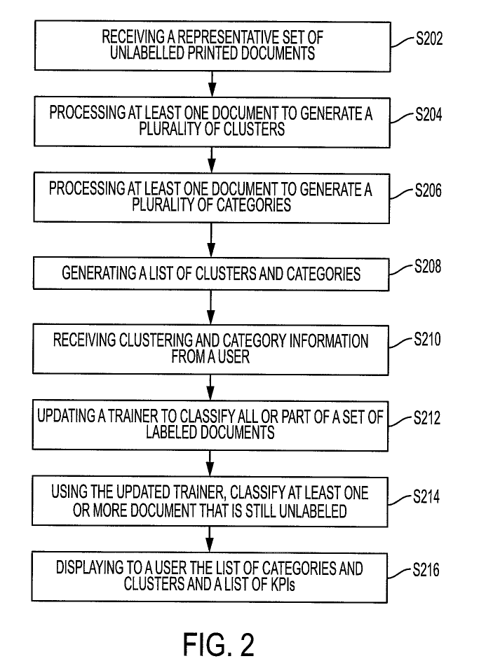

As illustrated in FIG. 2, an exemplary method clustering, categorizing and training a system for print job analysis which can be performed by the disclosed system is shown.

At S202, print job information is received. The print job information includes a representative set of unlabelled printed documents received from the one or more printing systems. At S204, at least one document from the representative set of unlabelled printed documents is used to generate a plurality of clusters of printed documents. Each cluster generated contains documents with a subset of similarities. At S206 at least one document from the representative set of unlabelled printed documents is processed to generate a plurality of categories of printed documents. Each of the categories contains documents with a subset of similarities. The S204 and S206 can be performed in either order consecutively or in parallel. A list of clusters and categories is then generated for user review at S208. At S210, upon reviewing the generated clusters and categories, the system receives document clustering information from a user for one or more documents based on the list of clusters and list of categories. At S212 a training module is updated that is configured to classify all or part of a set of labelled documents. Using the updated trainer, classifying one or more printed documents received from the first step that remain unlabelled S214 and finally, the results are displayed to a user S216. The results include a list of categories and clusters generated by the machine learning and human labelling phases and a list of KPIs generated based upon the representative set of unlabelled documents and the labelled documents.

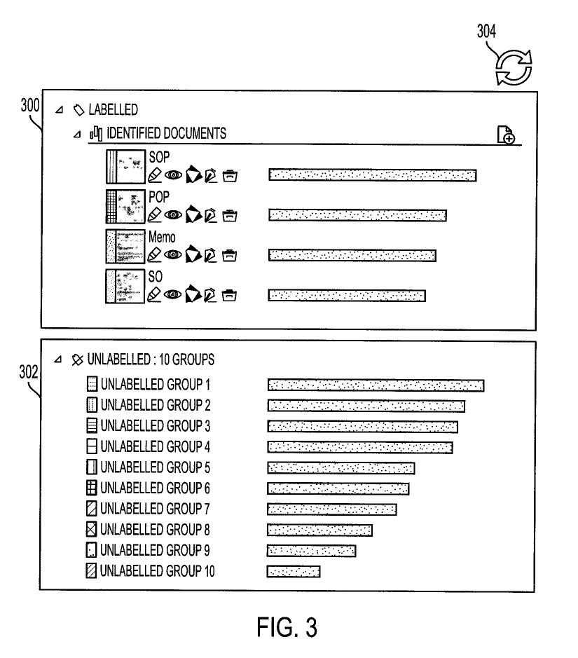

With respect to FIG. 3, illustrated are categories and clusters items generated by the machine learning phase. For example, all labelled documents 300 can be shown individually while groups of documents without labels 302 can be displayed to show the user the size of the group. The end user can select independently any of these items to start the human labelling process. The top right arrow button 304 allows to manually launch a new machine learning iteration.

In the human labelling phase 106 the auditor labels the documents grouped in clusters resulting from the clustering step 118 and validates the documents proposed for the different categories by the categorization step 120. The clustering and categorization steps provide two alternative and complementary ways to structure the access and labelling process of the remaining unlabelled documents 102.

In the first step, select cluster or category for document labelling 116, the auditor selects either a cluster (identified by the clustering algorithm) for in-cluster labelling 118 or an already identified category, i.e. the group of documents proposed for this category, for in-category document validation 120. One main objective in both cases is to do efficient mass labelling, i.e. to be able to select at each labelling action a large set of documents for one-shot assignment to a single category. The second objective of the in-cluster document labelling 118 step is furthermore to discover new categories, whereas the second objective of the in-category validation step 120 is rather to quickly improve the existing categorizers in terms performance. Depending on the size of the identified clusters and category-specific document groups, and thus on the expectation of achievable progress, the auditor chooses to favor either one or the other. Overall the system guides the auditor to favors clusters or category-groups that are of significant size 302.

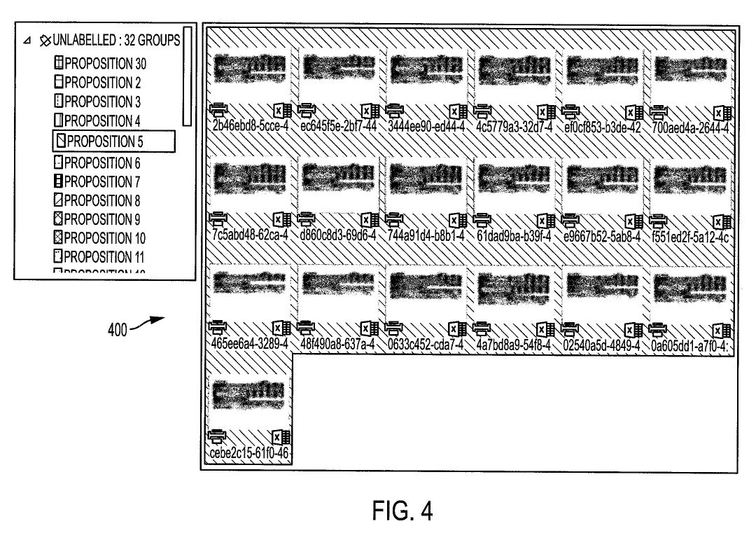

The main objective of the in-cluster document labelling step 118 is to discover new categories on the fly, inspired by the view of the documents in that cluster, or to spot large sets of additional documents that can be assigned to an already existing category. When the auditor comes across a homogeneous set of documents that belong to one category the auditor simply selects all the corresponding documents and labels them with the corresponding category. If that category does not yet exist it is created on the fly. With respect to FIG. 4, in the optimal case, all or nearly all documents in a given cluster belong to one and the same (new) category and can be labelled in one shot 400.

The default ordering of documents within a cluster (e.g., according to their increasing distance from the center/or according to sub-Clusters in case of hierarchical clustering) results in a default visual grouping of similar documents. If that grouping is not appropriate for one-shot labelling and/or if the cluster is not that homogeneous, when skimming through the documents in the cluster, the auditor may come across individual particularly salient documents that he immediately knows belong to a particular, possibly new category. In that case, he may select that document and activate the similar document retrieval function to ask the system to retrieve all similar documents and reorder the documents in the cluster based on their similarity with this selected salient document for easier one-shot labelling.

The main objective of the in-category validation step 120 is on one hand to efficiently reduce the volume of remaining unlabelled documents by quickly and in one shot assigning all the correctly classified documents to the proposed category and on the other hand to increase the categorizer performance by explicitly providing particularly valuable negative examples whenever rejecting false positive documents for the proposed category.

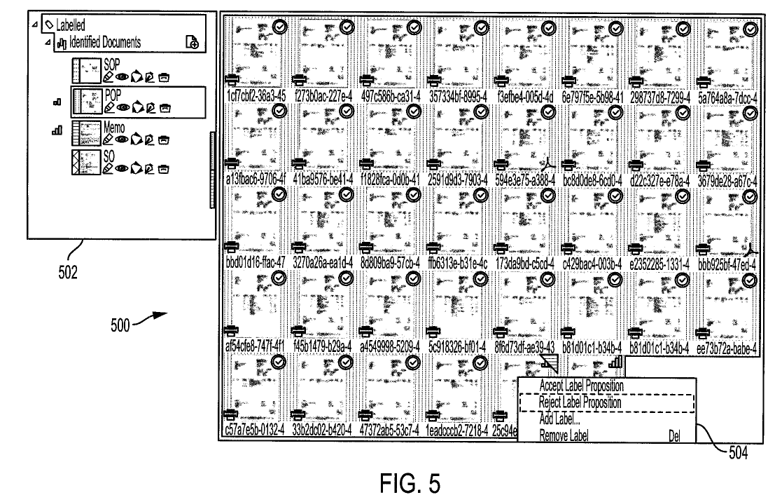

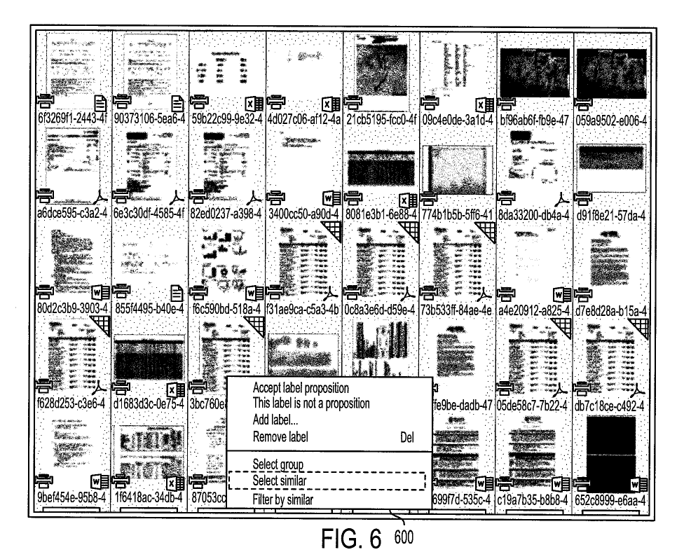

The category-rejection function, illustrated further in FIG. 5, can be augmented to provide also explicit labelling capability for rejected documents: when rejecting documents for the proposed category, the curator may then explicitly assign these document(s) to another category as he does in the in-cluster document labelling task 118. The curator may select a document 502 and choose to accept or reject the label 504. Further, the curator may select an existing category or create a new category 504, or use the similar document retrieval function to facilitate one-shot labelling in this context, see FIG. 6 600.

One possible extension, is to allow adjusting the confidence threshold for a category (e.g., by default only the documents >85% confidence are proposed, but the auditor may decide to go down to 70% if all the documents initially proposed really belong to that category

Different KPIs help the user to gauge when to terminate the labelling process and which cluster or category to select next during the human labelling step. The various KPI metrics help the user make key decisions at different moments in the overall process: 1. Cluster or category selection KPIs (FIG. 1): this KPI helps the user, during the human labelling step, to choose the next cluster or category to label, 2. Labelling velocity KPI: this KPI allows, during the human labelling step, to decide if/when to terminate the current human labelling step, i.e. to launch a new iteration starting with parallel clustering and classification of the remaining unlabelled documents, 3. Cost-benefit KPI (FIG. 3): this KPI allows, after the machine learning step, to gauge if/when to stop the overall process.

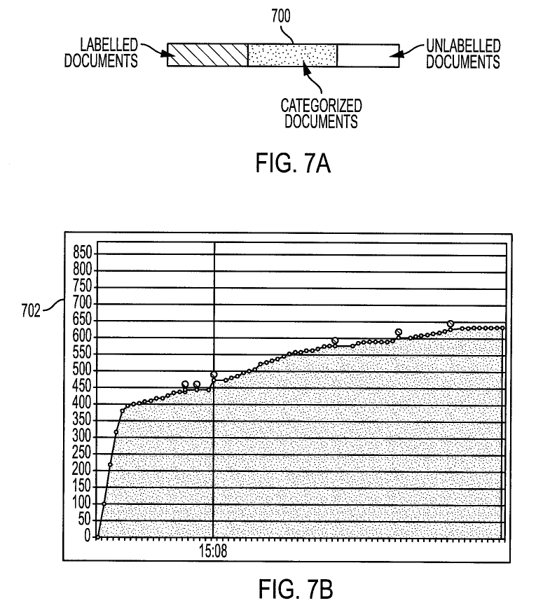

The Progress KPI allows, at each iteration, to gauge the overall progress, the speed and the efficiency of (each step of) the labelling process and its possible impact in terms of coverage of the overall document collection with sufficient confidence. With reference to FIGS. 7A and 7B, at each iteration following the machine learning step, the system computes the following data and provides them, e.g., in the progress bar 700 or in an efficiency graph 702 to the auditor:
Number/percentage of manually labelled documents (with respect to the total number of documents preselected for manual labelling)
Time spend in this iteration
Percentage of documents in the customer's overall document collection that can be categorized with sufficient confidence with the actual categorizers

The cost-benefit KPI allows to gauge, at each iteration, the expected cost and benefit of labelling more documents according to the overall current cluster and category size and heterogeneity. If the current clusters are well separated and dense, the auditor can expect easier labelling progress than if the clusters are not well separated and heterogeneous. Similarly, if many documents are classified with very high confidence into an existing category, the auditor can expect to very easily validate these documents and make quick progress with the labelling. During the human labelling step, this information about the cluster characteristics and the number of documents proposed for the different categories provides also indications to decide which cluster or category to select next during the human labelling phase for in-cluster labelling or in-category validation. The system may highlight to the user at each selection the most promising ones to choose. FIG. 3 represents this cost-benefits KPI for every category and cluster.

During the human labelling step 106, the user has to iteratively select individual clusters or categories 116 to work on. To help the user in making the most efficient choice, the system continuously analyses the characteristics of the individual clusters and categories to guide the user to the most promising ones. Therefore the system computes for each existing cluster or category a labelling KPI. This labelling KPI is computed from the cluster/category characteristics, taking into account on one hand the volume covered by each cluster/category in terms of unlabelled documents and/or pages contained, and on the other hand from its homogeneity (FIG. 1). Indeed, if a cluster or category covers a high volume of very homogeneous documents the user can expect to quickly and easily make significant labelling progress when selecting it: he should be able to label all these homogeneous documents in one shot. If hierarchical clustering is used, clusters that contain large homogeneous sub-clusters are highlighted as promising for efficient progress. To compute the homogeneity of the documents in a cluster or category the system computes the distance between the documents it contains. Finally, to point the user to the most promising clusters or categories the system highlights these characteristics when the user has to choose the cluster or category to work on next.

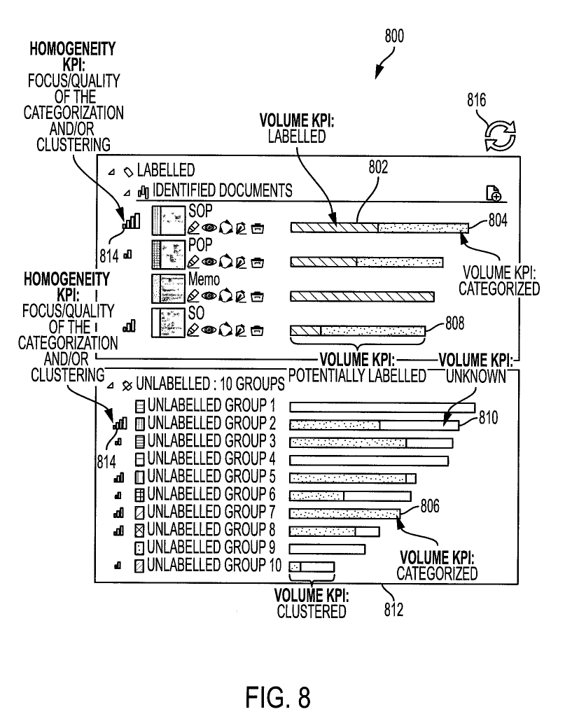

With reference to FIG. 8, the clustering/categorization labelling KPI is composed of volume and homogeneity KPIs. The volume KPI represents the number of documents/pages inside a category (“potentially labelled”) or cluster (“clustered”). This KPI informs the user of the potential impact in number of documents/pages the user may have by labelling all the documents in that category or cluster. The volume KPI contains sub indicators which help predict the impact of labelling the corresponding documents. For example, for labelled documents, a volume KPI bar can be displayed to the user showing the number of documents/pages that were manually labelled with that category and represents the work already accomplished towards learning the corresponding categorizer model 802. Additionally, a volume KPI bar can be displayed 804 indicating the currently unlabelled documents/pages that the system is able to categorize with sufficient confidence into one of the corresponding existing categories. Such documents appear in two groups, in one category and in one cluster. For each existing document category 806 the “categorized” bar represents the additional (currently unlabelled) documents/pages that the system proposes to add to that category. For each cluster 808 the “categorized” bar represents the documents/pages belonging to that cluster that the system is also able to categorize in one of the existing categories. In other words, these documents are accessible to the user in two ways, through the corresponding proposed category on one hand (the part for which the user is guided and enabling the user to directly accept or reject the category proposed by the system) and through the corresponding cluster on the other hand.

Another volume KPI indicator 810 may be present only for clusters 708 and represents the number of documents/pages that the system is currently not able to categorize with sufficient confidence into one of the existing categories. It represents documents that are potentially more difficult to label on one hand but that may allow to identify new additional categories on the other hand.

All volume indicator bars in the cluster section 808 indicate documents belonging to a category representing “potentially labelled” overall volume of documents/pages in that category, i.e. the volume the category is expected to represent once the user has validated corresponding categorized documents proposed by the system. The entire volume KPI bar 812 shown in the cluster section 708 represents the “clustered” overall volume of documents/pages grouped in that cluster.

The homogeneity KPI 814 is represented by a 1 to 4 bar icon on the left of each category/cluster. It indicates the homogeneity of a category or cluster in 5 degrees ranging of from very heterogeneous groups (0 bar), where the contained documents are overall not very similar to each other, over intermediate values (1, 2 or 3 bars) to very homogenous group (4 bars), where the contained documents are overall very similar to each other. The system may compute this degree for instance by averaging over all pairwise document-to-document similarities, or by computing the difference between the min and the max similarity. The resulting values can either be normalized or compared to thresholds, to obtain a value between 0 and 4. The resulting value helps the user to gauge if the category or cluster is rather coherent or not, and how easy or difficult its labelling it will be.

Whenever none of the current clusters contains any significant homogeneous document set anymore (minimum similarity or maximum distance under or below a threshold), the system advises the user to re-iterate a machine learning step. Still this remains under the users control because especially re-clustering may reshuffle the remaining unlabelled documents into new and completely different clusters which may in turn disturb the user if he already had identified additional documents to label within the previous cluster structure.

To gauge the labelling progress, the system also monitors the user's labelling velocity. This labelling velocity represents how fast a user advances with the manual labelling process in terms of document volume labelled per time spent. The labelling velocity is computed for each labelling action separately, once a cluster or category has been selected. Each time the user labels a document set the system computes a value, using the time elapsed since the last labelling action (or the selection of the cluster or category), i.e., the time spent for identifying and selecting the document set labelled in this action. When working through a selected cluster or category, this labelling velocity will naturally decline as the user naturally starts with labelling the largest set of homogeneous documents in the cluster or category and then iterates labelling smaller and smaller sets. Once the velocity decreases significantly and reaches a lower threshold the system informs the user, e.g., by flashing the corresponding category/cluster if another promising cluster or category still remains, or by flashing the iteration button to launch a new machine learning iteration 816 otherwise. Still, the user decides whether to keep working on the current cluster or category or to leave it. Following a machine learning iteration the labelling velocity is expected to increase, as the remaining documents have been regrouped in new meaningful clusters and categorized sets. If that is not the case and the labelling velocity remains below a threshold this is a first indication that the benefit of continuing the labelling process may be limited with respect to the cost.

The cost-benefit KPI provides an indication of the interest for the user to continue the overall labelling process. It is re-computed at the end of each machine learning step as a synthesis measure integrating the already achieved labelling progress on one hand and the expected facility to make progress with labelling further documents on the other hand.

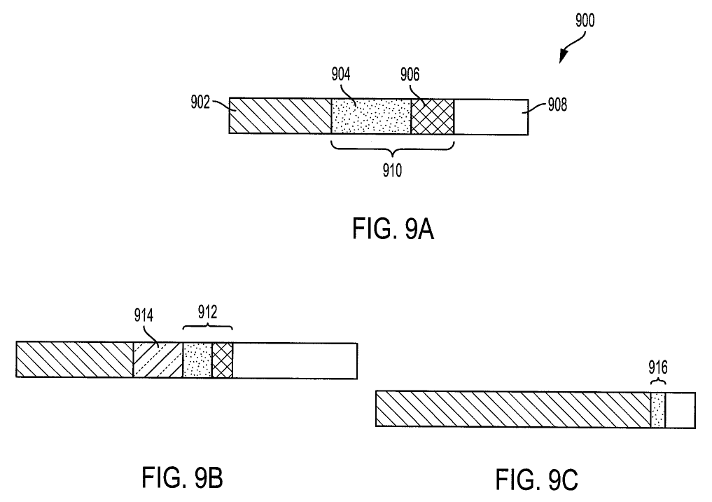

The cost-benefit KPI is represented by a gauge as shown in FIG. 9A. This gauge is re-initialized at each machine learning step and dynamically updated during the following manual labelling step. The gauge includes a visual indicator of all documents 900. One portion of the gauge represents the total volume of manually “labelled” documents/pages when the machine learning step was executed 902. It is extended dynamically on its right during the human labelling step whenever additional documents are labelled. Another portion of the gauge represents the total volume of documents that the system proposes to assign to the different existing categories based on the categorizer models trained in the machine learning step 904. This is based on the manually labelled documents available at training time 902, with the rationale being that these documents are easy to label, simply requiring either to accept or to reject the proposed category. During human labelling, this portion of the gauge will get smaller and smaller whenever the user accepts or rejects corresponding documents. The corresponding volume from this portion of the gauge 904 will mostly move into the labelled documents section 902 documents are accepted for a category, but some may also move into yet another portion of the gauge when documents are rejected 908.

Another portion of the gauge represents the total volume of homogeneous clustered documents (i.e., excluding documents that are already included in the grey bar) 906. The rationale is that these documents are easy to label in one shot as large homogeneous sets, possibly allowing identifying new relevant categories. The corresponding volume from this section will diminish as the user labels corresponding documents.

The portion of the gauge represents the remaining documents 908, i.e., those that are expected to be more difficult and tedious to label than those included in the grey and blue bars.

With respect to FIG. 9B, following the machine learning step and the re-initialization of the gauge, the system adjusts it dynamically during the manual labelling step. Each time the user labels additional documents the corresponding sections of the gauge are updated, e.g. when the user accepts a set of documents proposed for a category, the corresponding volume is moved from the remaining to label documents 912 into the clustered/categorized document section 914. Once the user has labelled all “easy to label” documents 916 and the labelling velocity is low, the system proposes to launch a new machine learning step. With respect to FIG. 8C, ultimately, after a number of iterations, the amount of easy-to-label 912 documents will diminish and not be significant anymore. At that time, corresponding also to low labelling velocity, the system will suggest to stop the labelling process.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method for interactive labelling of documents associated with one or more printing systems used in an organization, the method comprising:
a) receiving a representative set of unlabelled printed documents from the one or more printing systems;
b) processing at least one document from the representative set of unlabelled printed documents to generate a plurality of clusters of printed documents, where each cluster contains documents with a subset of similarities;
c) processing at least one document from the representative set of unlabelled printed documents to generate a plurality of categories of printed documents, where each category contains documents with a subset of similarities;
d) generating a list of clusters and categories for user review;
e) receiving document clustering information for one or more documents based on the list of clusters;
f) receiving document category validation information from a user for one or more documents based on the list of categories;
g) updating a trainer to classify all or part of a set of labelled documents from the machine learning and human labelling phases;
h) using the updated trainer, classifying one or more printed documents received in step a) which remain unlabelled; and
i) displaying to a user a list of categories and clusters generated by the machine learning and human labelling phases and a list of KPIs generated based upon the representative set of unlabelled documents and the labelled documents.

2. The method of claim 1, wherein generating a plurality of clusters of printed documents further includes grouping remaining unlabelled documents to obtain a limited number of homogenous clusters for review by a user.

3. The method of claim 1, wherein generating a plurality of categories further includes:
generating a set of proposed categories based on available sets of already labelled documents;
receiving documents proposed by a categorizer to quickly reduce the number of remaining unlabelled documents;
reviewing the proposed documents to accept relevant documents and remove irrelevant documents from the proposed categories; and
updating a categorizer model using the relevant and irrelevant documents.

4. The method of claim 1, wherein receiving document clustering information includes receiving a homogenous set of documents belonging to a list of available categories, labelled with the corresponding category.

5. The method of claim 4, wherein if the category does not exist, updating the list of available categories to include the category.

6. The method of claim 1, wherein receiving document clustering information further includes selecting an salient document to identify, retrieve and select the group of similar documents for labelling and reorder the documents according to their similarity with this document.

7. The method of claim 4, wherein the document clustering information includes a default visual grouping of similar documents.

8. The method of claim 1, receiving document category validation information from a user further includes reviewing proposed categories for labelled documents and accept or reject the category label for the proposed document.

9. The method of claim 1, wherein displaying provides a KPI to gauge current progress, providing feedback about the actual progress and efficiency of the labelling process and its possible impact in terms of coverage of the overall document collection with sufficient confidence.

10. The method of claim 5, wherein the KPI can further gauge cost and benefit of labelling more documents according to the current cluster and category characteristics and heterogeneity.

11. A system for interactive labelling of documents associated with one or more printing systems used in an organization, the system comprising:
a) a receiving a representative set of unlabelled printed documents from the one or more printing systems;
b) a clustering component configured to process at least one document from the representative set of unlabelled printed documents to generate a plurality of clusters of printed documents, where each cluster contains documents with a subset of similarities;
c) a categorizer component configured to process at least one document from the representative set of unlabelled printed documents to generate a plurality of categories of printed documents, where each category contains documents with a subset of similarities;
d) a compiler configured to generate a list of clusters and categories for user review;
e) a receiver configured to received document clustering information for one or more documents based on the list of clusters and document category validation information from a user for one or more documents based on the list of categories;
f) a training component configured to classify all or part of a set of labelled documents from the machine learning and human labelling phases and using the updated trainer, classifying one or more printed documents received in step a) which remain unlabelled; and
g) a display configured to display to a user a list of categories and clusters generated by the machine learning and human labelling phases and a list of KPIs generated based upon the representative set of unlabelled documents and the labelled documents.

12. The system of claim 11, wherein the clustering component is further configured to group remaining unlabelled documents to obtain a limited number of homogenous clusters for review by a user.

13. The system of claim 11, wherein categorizer component is further configured to:
generate a set of proposed categories based on available sets of already labelled documents;
receive documents proposed by a categorizer to quickly reduce the number of remaining unlabelled documents;
review the proposed documents to accept relevant documents and remove irrelevant documents from the proposed categories; and
update a categorizer model using the relevant and irrelevant documents.

14. The system of claim 11, wherein the receiver is configured to receive a homogenous set of documents belonging to a list of available categories, labelled with the corresponding category.

15. The system of claim 14, wherein if the category does not exist, updating the list of available categories to include the category.

16. The system of claim 11, wherein the receiver is further configured to receive a selected salient document used to identify, retrieve and select the group of similar documents for labelling and reorders the documents according to their similarity with this document.

17. The system of claim 11 wherein the document clustering information includes a default visual grouping of similar documents.

18. The system of claim 11, receiving document category validation information from a user further includes reviewing proposed categories for labelled documents and accept or reject the category label for the proposed document.

19. The system of claim 11, wherein displaying provides a KPI to gauge current progress, providing feedback about the actual progress and efficiency of the labelling process and its possible impact in terms of coverage of the overall document collection with sufficient confidence.

20. A computer program product comprising a non-transitory recording medium storing instructions which, when executed by a computer processor, perform a method for interactive labelling of documents associated with one or more printing systems used in an organization, the method comprising:
a) receiving a representative set of unlabelled printed documents from the one or more printing systems;
b) processing at least one document from the representative set of unlabelled printed documents to generate a plurality of clusters of printed documents, where each cluster contains documents with a subset of similarities;
c) processing at least one document from the representative set of unlabelled printed documents to generate a plurality of categories of printed documents, where each category contains documents with a subset of similarities;
d) generating a list of clusters and categories for user review;
e) receiving document clustering information for one or more documents based on the list of clusters;
f) receiving document category validation information from a user for one or more documents based on the list of categories;
g) updating a trainer to classify all or part of a set of labelled documents from the machine learning and human labelling phases;
h) using the updated trainer, classifying one or more printed documents received in step a) which remain unlabelled; and
i) displaying to a user a list of categories and clusters generated by the machine learning and human labelling phases and a list of KPIs generated based upon the representative set of unlabelled documents and the labelled documents.
